(19) United States
(12) Patent Application Publication
(10) Pub. No.: US 2026/0247488 A1
(43) Pub. Date: Aug. 20, 2026

(54) UNLICENSED BANDS SENSING AND LOCALIZATION FOR 5G/6G IMPROVED COMMUNICATION

(71) Applicant: CABLE TELEVISION LABORATORIES, INC., Louisville, CO (US)

(72) Inventors: Mohammed ZOUROB, Castle Pines, CO (US); Rahil GANDOTRA, Boulder, CO (US)

(73) Assignee: CABLE TELEVISION LABORATORIES, INC., Louisville, CO (US)

(21) Appl. No.: 19/539,950

(22) Filed: Feb. 13, 2026

Related U.S. Application Data
(60) Provisional application No. 63/758,440, filed on Feb. 14, 2025.

(51) Int. Cl. H04W 84/12; H04L 67/12

(52) U.S. Cl. CPC H04W 84/12; H04L 67/12

(57) ABSTRACT

Various systems, apparatuses, and methods for providing Wi-Fi sensing data are provided. A network device receives a sensing service request via a network exposure function (NEF). The network device functions as a sensing function (SF) in a cellular core network. The network device generates and shares one or more sensing instructions with a user equipment (UE) to provide an indication to perform Wi-Fi sensing. The UE performs Wi-Fi sensing based on the one or more sensing instructions and transmits Wi-Fi sensing data to the network device. The network device processes the Wi-Fi sensing data to generate one or more sensing results. The network device provides the one or more sensing results to the NEF. The NEF exposes the one or more sensing results to an application function (AF).

### CROSS REFERENCE TO RELATED APPLICATIONS

This application claims the benefit of U.S. provisional application no. 63/758,440 filed on February 14, 2025 which is incorporated by reference as if fully set forth.

### BACKGROUND OF THE INVENTION

In conventional communication systems, communication devices transmit information based on their specific needs. In conventional cellular systems, various conventional standardized algorithms are used for its operations such as beamforming (beam search) and/or handover, etc. These algorithms are mostly exhaustive and repeated at different periods that can be associated with mobility of the devices, thereby being especially costly when licensed bands are used. Various techniques attempt to increase efficiency of such operations by integrating third party information such as accelerometers and/or third party mapping services, etc. These techniques are not accurate, especially indoor, and mostly rely on using the licensed bands.

### SUMMARY OF THE INVENTION

In various implementations of the present disclosure, a method performed by a network device is provided. The method comprises receiving, from a network exposure function (NEF), a sensing service request signal comprising one or more sensing parameters and an indication to perform Wi-Fi sensing. The method further comprises generating one or more sensing instructions based on the one or more sensing parameters. The method further comprises transmitting, to a user equipment (UE), a sensing configuration signal comprising the one or more sensing instructions and the indication to perform Wi-Fi sensing. The method further comprises receiving, from the UE, a sensing output signal comprising sensing data. The method further comprises generating a sensing service response signal based on the sensing data. The method further comprises transmitting the sensing service response signal to the NEF.

In an implementation, the sensing data comprises Wi-Fi sensing data.

In an implementation, the Wi-Fi sensing data comprises one or more of: raw Wi-Fi sensing data, or pre-processed Wi-Fi sensing data.

In an implementation, the one or more sensing parameters include: a sensing type, a target area, a wireless local area network (WLAN) identifier, a reporting periodicity, one or more accuracy requirements, one or more latency constraints, or an authorization context.

In an implementation, the sensing data further comprises cellular sensing data.

In an implementation, generating the sensing service response signal comprises aggregating the Wi-Fi sensing data and one or more of: the cellular sensing data, historical sensing data, or contextual data to generate aggregated sensing data.

In an implementation, the sensing service response signal comprises the aggregated sensing data.

In an implementation, generating the sensing service response signal comprises one or more of: filtering the sensing data; extracting one or more features from the sensing data; generating one or more inferences based on the sensing data; or generating metadata associated with the sensing data.

In an implementation, the metadata includes one or more of: a confidence level associated with the sensing data, one or more timestamps indicative of time of generation of the sensing data, or a geographic relevance indication associated with the sensing data.

In an implementation, the sensing configuration signal is transmitted to the UE via an access and mobility management function (AMF).

In an implementation, the sensing output signal is received from the UE via an internet protocol (IP) based interface.

In various implementations of the present disclosure, a network device comprising a transceiver and a processor is provided. The transceiver and the processor are configured to receive, from a network exposure function (NEF), a sensing service request signal comprising one or more sensing parameters and an indication to perform Wi-Fi sensing. The transceiver and the processor are configured to generate one or more sensing instructions based on the one or more sensing parameters. The transceiver and the processor are configured to transmit, to a user equipment (UE), a sensing configuration signal comprising the one or more sensing instructions and the indication to perform Wi-Fi sensing. The transceiver and the processor are configured to receive, from the UE, a sensing output signal comprising sensing data. The transceiver and the processor are configured to generate a sensing service response signal based on the sensing data. The transceiver and the processor are configured to transmit the sensing service response signal to the NEF.

In an implementation, the sensing data comprises Wi-Fi sensing data.

In an implementation, the Wi-Fi sensing data comprises one or more of: raw Wi-Fi sensing data, or pre-processed Wi-Fi sensing data.

In an implementation, the one or more sensing parameters include: a sensing type, a target area, a wireless local area network (WLAN) identifier, a reporting periodicity, one or more accuracy requirements, one or more latency constraints, or an authorization context.

In an implementation, the sensing data further comprises cellular sensing data.

In an implementation, generating the sensing service response signal comprises aggregating the Wi-Fi sensing data and one or more of: the cellular sensing data, historical sensing data, or contextual data to generate aggregated sensing data. The sensing service response signal comprises the aggregated sensing data.

In various implementations of the present disclosure, a method performed by a user equipment (UE) is provided. The method comprises receiving, from a core network (CN) function in a cellular network, a sensing configuration signal comprising one or more sensing instructions and an indication to perform Wi-Fi sensing. The method further comprises enabling, based on the one or more sensing instructions, one or more Wi-Fi measurement functions. The method further comprises performing the one or more Wi-Fi measurement functions over one or more Wi-Fi bands using Wi-Fi signaling to generate Wi-Fi sensing data. The method further comprises transmitting, to the CN function in the cellular network, a sensing output signal comprising the Wi-Fi sensing data.

In an implementation, the one or more Wi-Fi measurement functions comprise: collecting channel state information (CSI), performing one or more fine timing measurements, or performing one or more radio measurements.

In an implementation, the method further comprises generating, based on the sensing configuration signal, additional sensing data comprising one or more of: cellular sensing data, historical sensing data, or contextual data. In an implementation, the method further comprises generating the sensing output signal comprising a combination of the Wi-Fi sensing data and the additional sensing data.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1 is an illustration of an example device;

FIG. 2 illustrates an example communication system;

FIG. 3 illustrates an example of a functional split between a next generation radio access network (NG-RAN) and 5G core (5GC);

FIG. 4 illustrates an example of a protocol stack for a user plane and a control plane;

FIG. 5 is a schematic architecture diagram illustrating collection of Wi-Fi sensing data according to one or more implementations of the present disclosure;

FIG. 6 is a schematic architecture diagram illustrating collection of Wi-Fi sensing data according to one or more implementations of the present disclosure;

FIG. 7 is a schematic architecture diagram illustrating collection of Wi-Fi sensing data according to one or more implementations of the present disclosure;

FIG. 8 is a schematic architecture diagram illustrating collection of Wi-Fi sensing data according to one or more implementations of the present disclosure;

FIG. 9A is a schematic block diagram illustrating Wi-Fi sensing application enablement system according to one or more implementations of the present disclosure;

FIG. 9B is a schematic block diagram illustrating Wi-Fi sensing application enablement system according to one or more implementations of the present disclosure;

FIG. 10 is a flowchart illustrating a method performed by a network device according to one or more implementations of the present disclosure; and

FIG. 11 is a flowchart illustrating a method performed by a user equipment (UE) according to one or more implementations of the present disclosure.

### DETAILED DESCRIPTION

The underlying principle of a communication system is to enable one or more devices to communicate with one or more other devices. At a basic level, each device may need some basic components to operate. Any device referenced herein, including the hardware (e.g., virtual or physical) to run a function, software entity, application, or the like, may be understood to have at least one or more of the following components (e.g., where there may be one or more of each component): a processor, a transceiver (e.g., which may or may not be integrated with the processor), an input (e.g., microphone, keyboard, mouse, etc.), an output (e.g., port for outputting display signals, a display, a touch screen, a printer, etc.), a power source, a positioning chip (e.g., GPS, GLONASS, etc., which may or may not be integrated with the processor and/or transceiver), button (e.g., for controlling the specific function of one or more aspects of the device). These components may be operably connected to one another, meaning that there may be a direct connection or an indirect connection to one or more of the components.

A UE may be interchangeable with a station (STA), a mobile station, a fixed or mobile subscriber unit, a subscription-based unit, a pager, a cellular telephone, a personal digital assistant (PDA), a smartphone, a laptop, a netbook, a computer, a server, a functional entity (e.g., virtual and/or physical) a wireless sensor, a hotspot or Wi-Fi device, an Internet of Things (IoT) device, a watch or other wearable, a head-mounted display (HMD), a vehicle, a drone, or the like.

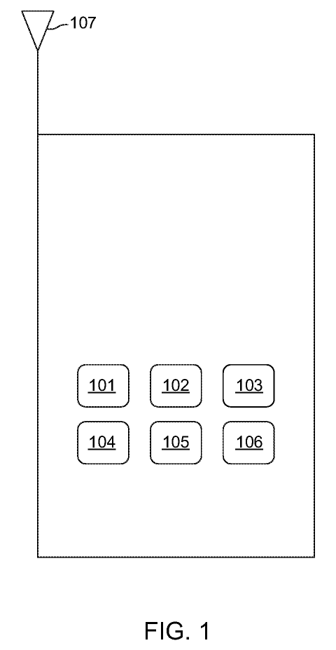

FIG. 1 is an illustration of an example device. In one case, the device may be a User Equipment (UE) suited for mobile operation. In this example, the UE may have a processor 101, a transceiver 102, a touchscreen 103, a power source 104 (e.g., a battery), a GPS 105, one or more other components 106 (e.g., as described herein), and/or an antenna 107.

Generally, a processor may be any kind of processor, such as a processor capable of carrying out one or more of the techniques described herein. A transceiver may be configured to transmit and receive signals. In one case, there may be a separate receiver and transmitter. A transceiver may be connected to one or more antennas (e.g., MIMO technology). A transceiver may be configured to transmit RF signals. In one case, a transceiver may be configured to transmit light signals (e.g., IR, UV, laser, etc.). A transceiver may be configured to send/receive more than one type of RF signal (e.g., different radio access technologies for one transceiver, or multiple transceivers each dedicated to a specific radio access technology). A transceiver may be configured to modulate signals for transmission, and demodulate signals for reception. The UE may be capable of full duplex operation, where there is transmission and reception of some or all signals may be concurrent and/or simultaneous (e.g., different timing/spacing for UL or DL).

Different radio access technologies may be used with one or more transceivers (e.g., WCDMA, CDMA2000, GSM, LTE, LTE-A, LTE-A Pro, NR etc.).

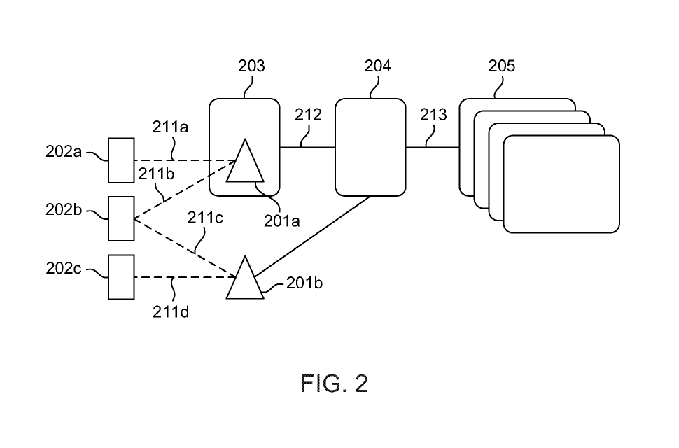

FIG. 2 illustrates an example communication system. This example may be used to illustrate multiple wireless protocols. For all wireless protocols, there may be mobile or stationary devices (e.g., 202a, 202b, 202c, such as a UE) that connect to a base station device 201a and/or 201b. In one case, this may enable a mobile device to connect to a service (e.g., a remote server) or data network (e.g., internet).

In one case, the base stations (201a, 201b) may be equivalent to, and/or interchangeable with, a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, transmission receive point (TRP), network (NW), RP (reception point), RRH (radio remote head), DA (distributed antenna), BS (base station), a sector (of a BS), and a cell (e.g., a geographical cell area served by a BS). Each base station may be representative of more than one base station (e.g., multiple transmission reception points).

Generally, a communication system may use a combination of wired and wireless connections at different points in the system. One or more wireless technologies (e.g., channel access methods), may include code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

A base station may be configured to transmit and/or receive wireless signals on one or more carrier frequencies, which may be referred to as a cell (not shown). A base station (201a, 201b) may communicate with one or more UEs (202a, 202b, 202c) over an air interface (211a, 211b, 211c, 211d).

In one case, one or more base stations may implement LTE radio access and NR radio access together, for instance using dual connectivity (DC) approach. Therefore, the system (e.g., and perhaps one or more UEs) may implement multiple types of radio access technologies that uses more than one type of base station (e.g., an eNB and a gNB).

In one case, the communication system may include a radio access network (RAN) 203, a core network 206, and one or more other elements represented by 205 (e.g., public switched telephone network (PSTN), the Internet, and other networks or the like).

In one scenario using FIG. 2 as an illustration, a RAN 203 may be in communication with a CN 204. The base station 201a may be an eNB, and the access technology may be based on E-UTRA (e.g., LTE, etc.). The communication system may handle data transmission from the UE 202a. The data may have varying quality of service (QoS) requirements, such as differing throughput requirements, latency requirements, error tolerance requirements, reliability requirements, data throughput requirements, mobility requirements, and the like. The CN 204 may provide call control, billing services, mobile location-based services, pre-paid calling, Internet connectivity, video distribution, etc., and/or perform high-level security functions, such as user authentication. Although not shown, the RAN 203 and/or the CN 204 may be in direct or indirect communication with other RANs that employ the same RAT as the RAN 203 or a different RAT. For example, in addition to being connected to the RAN 203, which may be utilizing a NR radio access technology, the CN 204 may also be in communication with another RAN (not shown) employing another radio access technology (e.g., E-UTRA, WiFi, etc.). Each of the eNBs may be associated with a particular cell (not shown) and may be configured to handle radio resource management decisions, handover decisions, scheduling of users in the UL and/or DL, and the like. Each eNB may communicate with one another over an X2 interface (not shown).

In one scenario using FIG. 2 as an illustration, the RAN 203 and the CN 204 may employ NR radio access technologies and related protocols. The base station may be a gNB 201. The gNB(s) may implement carrier aggregation technology, where multiple component carriers may be transmitted to the UE 202a. A subset of these component carriers may be on unlicensed spectrum while the remaining component carriers may be on licensed spectrum. The UE(s) may communicate with the gNB(s) using transmissions associated with a scalable numerology (e.g., subcarrier spacing, etc.). For example, the OFDM symbol spacing and/or OFDM subcarrier spacing may vary for different transmissions, different cells, and/or different portions of the wireless transmission spectrum. The UE(s) may communicate with gNB(s) using subframe or transmission time intervals (TTIs) of various or scalable lengths (e.g., containing a varying number of OFDM symbols and/or lasting varying lengths of absolute time). The gNB(s) may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF), routing of control plane information towards Access and Mobility Management Function (AMF), and the like. The gNB(s) may communicate with one another over an Xn interface.

Not shown (e.g., but still possibly part of one or more example scenarios described herein), the CN may include one or more AMF, one or more UPF, one or more Session Management Function (SMF), and/or one or more Data Networks (DNs). In one case, the aforementioned elements may be owned and/or operated by an entity other than the CN operator.

In one scenario using FIG. 2 as an illustration, an Internet 205 may include a global system of interconnected computer networks and devices that use common communication protocols, such as the transmission control protocol (TCP), user datagram protocol (UDP) and/or the internet protocol (IP) in the TCP/IP internet protocol suite.

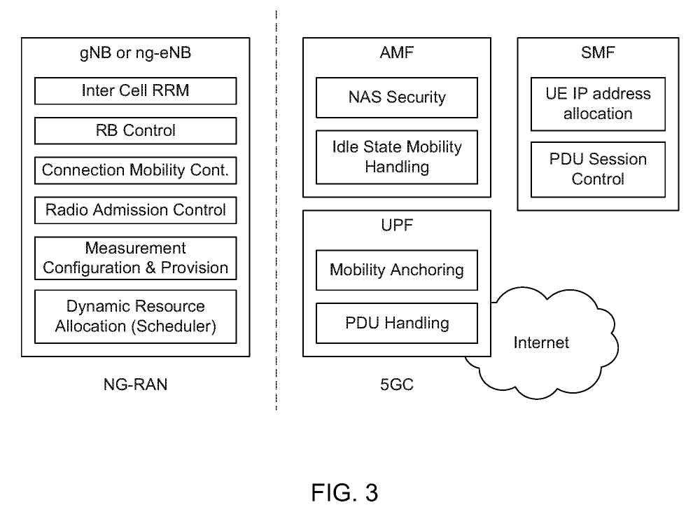

FIG. 3 illustrates an example of a functional split between the NG-RAN and 5GC. The AMF may be connected to one or more gNB the RAN via an N2 interface and may serve as a control node. For example, the AMF may be responsible for authenticating a support of the UE for network slicing (e.g., handling of different protocol data unit (PDU) sessions with different requirements), selecting a particular SMF, management of the registration area, termination of non-access stratum (NAS) signaling, mobility management, and the like. Network slicing may be used by the AMF in order to customize CN support for one or more UEs based on the types of services being utilized by the respective UE. For example, different network slices may be established for different use cases such as services relying on ultra-reliable low latency (URLLC) access, services relying on enhanced massive mobile broadband (eMBB) access, services for MTC access, and the like. The AMF may provide a control plane function for switching between the RAN and other RANs that employ other radio technologies (e.g., as described herein). The SMF may be connected to an AMF in the CN via an N11 interface. The SMF may also be connected to a UPF in the CN via an N4 interface. The SMF may select and control the UPF and configure the routing of traffic through the UPF. The SMF may perform other functions, such as managing and allocating UE IP address, managing PDU sessions, controlling policy enforcement and QoS, providing DL data notifications, and the like. A PDU session type may be IP-based, non-IP based, Ethernet-based, and the like. The UPF may be connected to one or more gNB in the RAN via an N3 interface, which may provide a UE with access to packet-switched networks, such as the Internet, to facilitate communications between one or more UEs and IP-enabled devices. The UPF may perform other functions, such as routing and forwarding packets, enforcing user plane policies, supporting multi-homed PDU sessions, handling user plane QoS, buffering DL packets, providing mobility anchoring, and the like. The CN may facilitate communications with other networks. For example, the CN may provide a UE with access to the other networks 212, which may include other wired and/or wireless networks that are owned and/or operated by other service providers. In one example, the UEs may be connected to a local DN through a UPF via an N3 interface to the UPF and an N6 interface between the UPF and the DN. As discussed herein, a NR RAN may be called an NG-RAN and a NR CN may be called a 5GC.

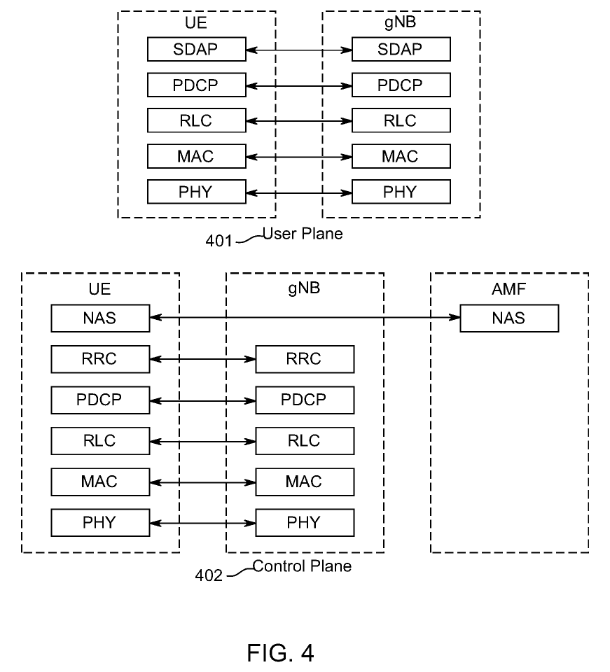

FIG. 4 illustrates an example protocol stack for a user plane and a control plane, including a user plane protocol stack 401 and a control plane stack 402. A higher layer may refer to one or more layers in a protocol stack, or a specific sublayer within the protocol stack. The protocol stack may comprise of one or more layers in a UE or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: Non Access Stratum (NAS), Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 1 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

Various embodiments of the present disclosure provide sensing in one or more unlicensed bands and/or localization for fifth generation (5G) and/or sixth generation (6G) improved communication. Various methods provided by the present disclosure leveraging non-3GPP information to enhance an operation of a 3GPP network. Various methods of the present disclosure provide increased energy savings for devices and increased licensed spectrum utilization for networks.

Integrated sensing and communications (ISAC) refers to a unified system paradigm in which radio signals and network infrastructure are jointly leveraged to support both data communications and environmental sensing. Rather than treating sensing as a standalone function, ISAC embeds one or more sensing capabilities into existing communication waveforms, protocols, and/or network elements etc., enabling the extraction of contextual information, such as but not limited to presence, motion, localization, and/or activity from routine signal exchanges etc. Within cellular systems, this approach allows sensing data to be generated, processed, and/or distributed using standardized radio access and/or core network functions, benefiting from established mechanisms for synchronization, mobility management, quality of service, and/or security etc. As a result, ISAC transforms a cellular network into a pervasive sensing platform while minimizing incremental spectrum, hardware, and/or signaling overhead etc.

Incorporating Wi-Fi sensing within a cellular sensing framework further extends the scope and value of ISAC by federating heterogeneous sensing sources. Wi-Fi signals, particularly in dense indoor and enterprise environments, provide high spatial resolution and rich multipath characteristics that are well suited for fine-grained sensing use cases such as but not limited to occupancy detection, gesture recognition, and/or indoor localization etc. By transporting Wi-Fi sensing data through a cellular core, these capabilities can be integrated with cellular-derived sensing information, enabling cross-domain correlation, centralized analytics, and/or exposure to applications via standardized interfaces etc. This integration enables broader coverage continuity across access technologies, consistent policy enforcement, and/or scalable data distribution to authorized consumers. Moreover, leveraging the cellular core for aggregation and exposure of Wi-Fi sensing data reduces fragmentation across sensing ecosystems and supports the development of unified sensing services that are access-agnostic, secure, and/or deployable at scale.

Wi-Fi, Bluetooth and several other radio access technologies (RATs) leverage unlicensed bands. Traditional localization techniques can be implemented using several of those RATs. If a device is mobile within a certain environment, it can be localized and/or sensed in that environment using, for example, triangulation. Feeding this information that was captured over unlicensed bands back to a 5G or cellular core may provide the cellular network more information about the location of said device. This may translate to less exhaustive operations such as beam search and would lead to power savings on the device side, and would mean increasing the utilization efficiency of licensed bands that the cellular network may be operated in. Moreover, various techniques of the present disclosure can be used to pool in sensing information from 3GPP and non-3GPP sources for one or more third parties who can benefit from the sensing information or process the sensing information for the benefit of the core network.

In various embodiments, sensing over unlicensed bands using RATs such as Wi-Fi or Bluetooth low energy (BLE) can be managed using a 5G or cellular core (e.g., processing and control).

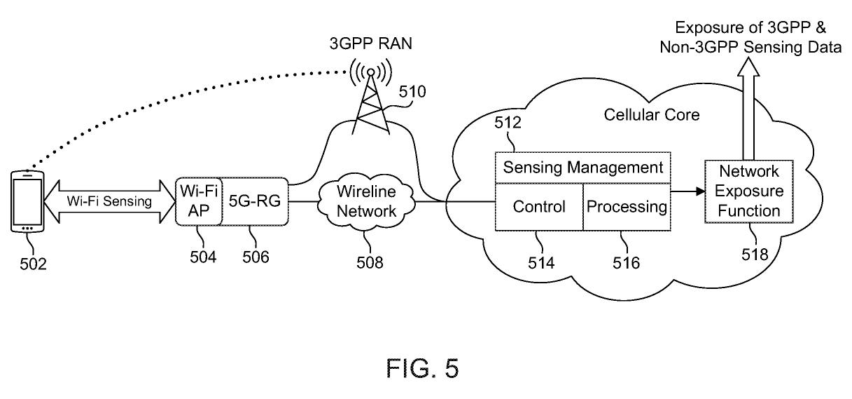

Referring now to FIG. 5, a schematic architecture diagram illustrating collection of Wi-Fi sensing data is shown according to one or more implementations of the present disclosure. The architecture includes a UE 502, a Wi-Fi access point (AP) 504, a fifth-generation residential gateway (5G-RG) 506, a wireline network 508, a third-generation partnership project (3GPP) RAN 510, a sensing management function 512 comprising a control function 514 and a processing function 516, and a network exposure function (NEF) 518.

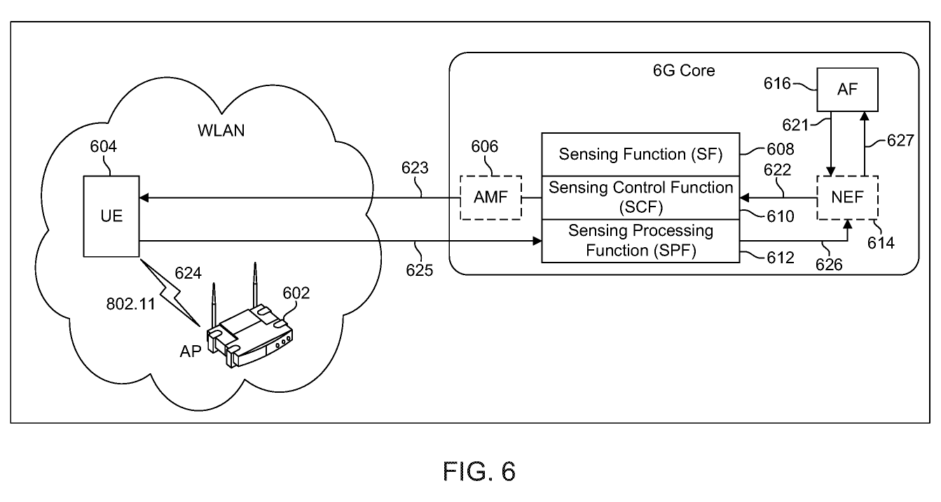

Referring now to FIG. 6, a schematic architecture diagram illustrating collection of Wi-Fi sensing data is shown according to one or more implementations of the present disclosure. The architecture includes an AP 602, a UE 604, an AMF 606, a sensing function (SF) 608 comprising a sensing control function (SCF) 610 and a sensing processing function (SPF) 612, a NEF 614, and an application function (AF) 616.

At 621, a sensing service request is sent from an application layer (e.g., the AF 616). The AF 616 submits a sensing service request to the NEF 614. The sensing service request may include but is not limited to one or more sensing parameters, such as a sensing type (e.g., presence, motion, and/or activity detection etc.), a target area and/or a wireless local area network (WLAN) identifier, reporting periodicity, accuracy requirements, latency constraints, and/or authorization context etc., for example. The NEF 614 performs initial validation and one or more policy checks prior to forwarding the sensing service request.

At 622, the NEF 614 forwards the sensing service request to the sensing control plane (e.g., the SF 608). The NEF 614 forwards the validated sensing service request to the SCF 610 within the SF 608. The SF 608 translates the application-level request into network-internal sensing control instructions, including selection of access technology (e.g., Wi-Fi), applicable WLAN domains, etc. based on a target sensing area, supported sensing area of sensing entity, etc.

At 623, the SCF 610 coordinates, directly or via the AMF 606, with the UE 604 to enable or authorize participation in Wi-Fi sensing. In an example, step 623 may include provisioning of sensing-related configuration parameters, identifiers, and/or security context etc., for example.

At 624, Wi-Fi sensing data is acquired via WLAN. The UE 604 performs Wi-Fi sensing using IEEE 802.11 signaling, such as channel state information (CSI), fine timing measurements, and/or other radio measurements. In some cases, raw and/or pre-processed sensing data is collected locally at the UE 604 without requiring changes to the underlying Wi-Fi air interface procedures.

At 625, Wi-Fi sensing data is delivered to the cellular core. The collected Wi-Fi sensing data is transmitted from the UE 604 to the cellular core network and delivered to the SPF 612. The transport may occur over an internet protocol based (IP-based) interface and may leverage secure tunneling and/or WLAN interworking function, depending on deployment configuration.

At 626, sensing data is processed and prepared for exposure. In case the SPF 612 receives raw Wi-Fi sensing data, the SPF 612 may either process the raw Wi-Fi sensing data or transparently forward the raw Wi-Fi sensing data upstream. In case the SPF 612 processes the Wi-Fi sensing data, the SPF 612 may additionally fuse the Wi-Fi sensing data with cellular-derived sensing information and/or historical context data etc. In an example, processing the Wi-Fi sensing data may include but is not limited to filtering, feature extraction, inference, and/or aggregation. In an example, resulting sensing output is forwarded to the NEF 614 for exposure, along with associated metadata such as confidence levels, timestamps, and/or geographic relevance etc., for example.

At 627, the sensing results are exposed to the application. The NEF 614 exposes the raw or processed sensing results to the AF 616 using standardized application programming interfaces (APIs). The AF 616 may receive the sensing information in real time and/or via periodic notifications, enabling the application to consume Wi-Fi–derived sensing insights through the cellular sensing framework in a secure and access-agnostic manner.

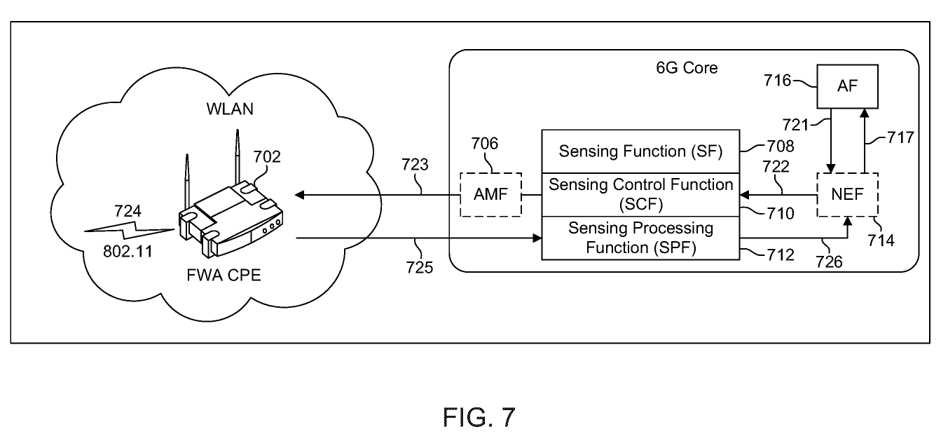

Referring now to FIG. 7, a schematic architecture diagram illustrating collection of Wi-Fi sensing data is shown according to one or more implementations of the present disclosure. The architecture includes a fixed wireless access (FWA) customer premises equipment (CPE) FWA CPE 702, an AMF 706, a SF 708 comprising a SCF 710 and a SPF 712, a NEF 714, and an AF 716.

At 721, a sensing service request is sent from an application layer (e.g., an AF 716). The AF 716 initiates the sensing service request toward the NEF 714. The request specifies one or more sensing requirements, including a sensing objective, a geographic or premises-specific scope associated with an FWA deployment, reporting criteria, and/or authorization information etc. The request may further indicate that sensing data derived from WLAN infrastructure is requested.

At 722, sensing control information is translated and distributed. The NEF 714 forwards the sensing service request to the SCF 710 within the SF 708. The SCF 710 translates the application-level sensing request into one or more control instructions applicable to WLAN-based sensing, including identification of one or more fixed wireless access (FWA) CPE devices capable of performing Wi-Fi sensing and corresponding configuration parameters.

At 723, the SCF 710 coordinates, directly or via the AMF 706, with the FWA CPE 702 to enable or authorize participation in Wi-Fi sensing. In an example, step 723 may include provisioning of sensing-related configuration parameters, identifiers, and/or security context etc., for example.

At 724, Wi-Fi sensing is performed by the FWA CPE 702. The FWA CPE 702, operating as a WLAN access point, performs Wi-Fi sensing using IEEE 802.11 signaling. The sensing may rely on measurements such as channel state information, received signal characteristics, and/or timing-based measurements obtained from communications with one or more WLAN stations within the coverage area. The sensing operation may be performed without requiring modification to standard Wi-Fi communication procedures.

At 725, the sensing data is reported to the cellular core. The FWA CPE 702 transmits raw or pre-processed Wi-Fi sensing data to the cellular core network. The sensing data is delivered to the SPF 712 using a secure IP-based interface.

At 726, the sensing information is processed and aggregated. In case the SPF 712 receives raw Wi-Fi sensing data, the SPF 712 may either transparently forward the raw Wi-Fi sensing data upstream or may process the raw Wi-Fi sensing data to generate sensing outputs, which may include but are not limited to detection results, activity indicators, occupancy estimates, and/or other inferred environmental characteristics. The SPF 712 may further aggregate and/or correlate the Wi-Fi sensing data with additional network information and/or historical sensing data prior to exposure.

At 727, the sensing results are exposed to the application. The raw or processed sensing results are forwarded from the SPF 712 to the NEF 714, which exposes the sensing information to the AF 716 via one or more standardized APIs. The AF 716 receives the sensing output in accordance with the requested reporting mode, enabling applications to consume WLAN-derived sensing insights through the cellular core network.

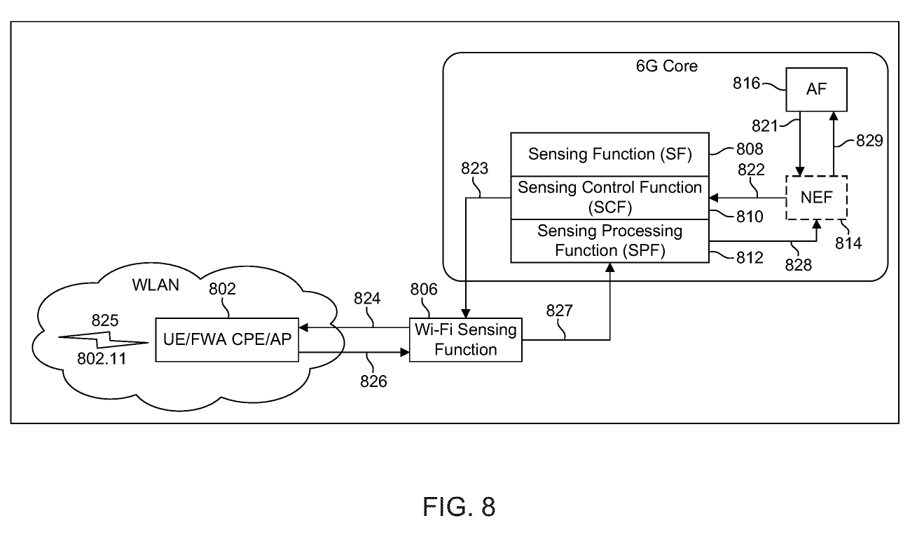

Referring now to FIG. 8, a schematic architecture diagram illustrating collection of Wi-Fi sensing data is shown according to one or more implementations of the present disclosure. The architecture includes a UE/FWA CPE/AP 802, a Wi-Fi SF 806, a SF 808 comprising a SCF 810 and a SPF 812, a NEF 814, and an AF 816.

At 821, a sensing service request is received from application (e.g., the AF 816). The AF 816 transmits a sensing service request to the NEF 814. The sensing service request identifies one or more sensing objectives and may include parameters such as but not limited to sensing type, target environment, reporting mode, latency requirements, and/or authorization information etc. The sensing service request may indicate that sensing data derived from Wi-Fi radio measurements is requested.

At 822, the sensing request is forwarded to the sensing control plane. The NEF 814 forwards the sensing service request to the SCF 810 within the SF 808. The SCF 810 interprets the application-level request and determines one or more control actions required to fulfill the sensing service, including selection of sensing sources and/or coordination with external sensing functions.

At 823, the SF 808 coordinates with the Wi-Fi SF 806. The SCF 810 initiates coordination with the Wi-Fi SF 806. The coordination may include provisioning of sensing configuration parameters, selection of one or more WLAN domains or devices, and/or establishment of control context for Wi-Fi-based sensing etc. The Wi-Fi SF 806 may be deployed within the cellular core or as an external logical function.

At 824, one or more sensing-capable WLAN devices are configured. The Wi-Fi SF 806 configures one or more sensing-capable devices within a WLAN, including a UE, an FWA CPE, and/or a Wi-Fi AP. In an example, the configuration may specify sensing measurements to be collected, reporting triggers, timing constraints, and/or privacy or policy controls etc.

At 825, Wi-Fi sensing data is acquired. The configured WLAN device performs Wi-Fi sensing using IEEE 802.11 signaling. The sensing operation may involve collection of channel state information, signal strength variations, timing measurements, and/or other radio characteristics exchanged during normal Wi-Fi communication. The sensing is performed without altering standard WLAN communication procedures.

At 826, the Wi-Fi sensing data is reported. The WLAN device transmits raw or pre-processed Wi-Fi sensing data to the Wi-Fi SF 806. The reporting may occur periodically, event-triggered, and/or on-demand, and may utilize secure IP-based transport.

At 827, the sensing data may be delivered to the cellular sensing processing function. In case the Wi-Fi SF 806 receives raw Wi-Fi sensing data, the Wi-Fi SF 806 may either transparently forward the received raw Wi-Fi sensing data to the SPF 812 within the cellular SF or may process the received Wi-Fi sensing data and forward the sensing result to the SPF 812. The forwarded data may include associated metadata such as timestamps, device identifiers, and/or location context.

At 828, the sensing results are processed and exposed. In case the SPF 812 receives raw Wi-Fi sensing data from the Wi-Fi SF 806, the SPF 812 may either transparently forward the received raw Wi-Fi sensing data or may process the received Wi-Fi sensing data to generate sensing outputs, which may include inferred environmental or activity information. The processing may include aggregation, fusion with other sensing sources, and/or application of inference models. The resulting sensing information is forwarded to the NEF 814 for exposure.

At 829, the sensing results are exposed to the application. The NEF 814 exposes the raw or processed sensing results to the AF via one or more standardized APIs. The AF 816 receives the sensing output according to the requested delivery mode, enabling applications to consume Wi-Fi-derived sensing insights through the cellular sensing framework.

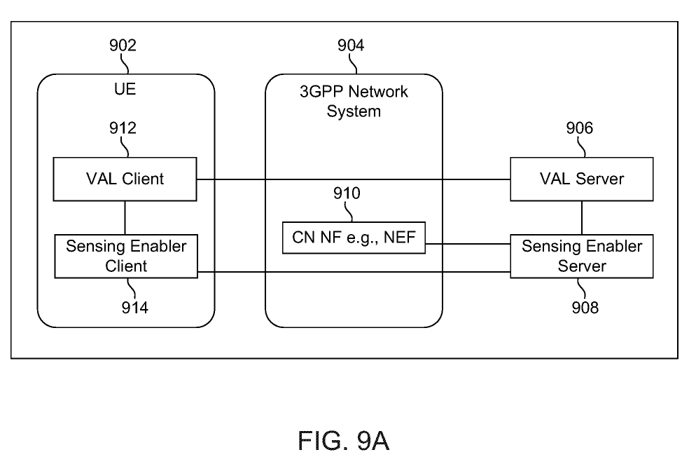

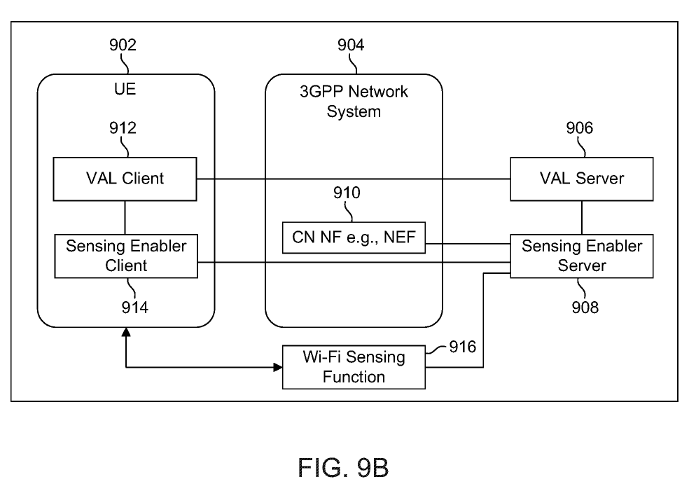

Referring now to FIG. 9A, a schematic block diagram of Wi-Fi sensing application enablement system is shown according to one or more implementations of the present disclosure. The Wi-Fi sensing application enablement system includes a UE 902, a 3GPP network system 904, a vertical application layer (VAL) server 906, a sensing enabler server 908. The 3GPP network system 904 includes a core network (CN) 910. The UE 902 includes a VAL client 912 and a sensing enabler client 914.

Referring now to FIG. 9B, a schematic block diagram of Wi-Fi sensing application enablement system is shown according to one or more implementations of the present disclosure. The Wi-Fi sensing application enablement system includes a UE 902, a 3GPP network system 904, a VAL server 906, a sensing enabler server 908. The 3GPP network system 904 includes a CN 910. The UE 902 includes a VAL client 912 and a sensing enabler client 914. The Wi-Fi sensing application enablement system includes a Wi-Fi SF 916.

A sensing enabler server 908 may be a standalone server or part of the service enabler architecture layer (SEAL) server, exposes Wi-Fi sensing capabilities to one or more VAL servers and one or more VAL clients through one or more application layer APIs.

The sensing enabler server 908 maintains a registry of available Wi-Fi sensing capabilities, including but not limited to supported sensing types, coverage scope, accuracy levels, and/or reporting modes etc. One or more applications and/or VAL servers may discover and query these capabilities via the sensing enabler client 914 and/or the sensing enabler server 908 interface, allowing dynamic selection and matchmaking of Wi-Fi sensing services based on one or more application requirements.

The one or more VAL clients or the one or more VAL servers issue sensing requests to the sensing enabler server 908 and/or the sensing enabler client 914.

The sensing enabler client 914 may be a standalone client and/or part of the SEAL client function, that allows collecting, and/or optionally processing, Wi-Fi sensing data on the UE 902.

The sensing enabler client 914 and/or the sensing enabler server 908 support one or more event-based and subscription-based delivery models for Wi-Fi sensing outputs. One or more applications may subscribe to sensing events and/or conditions, and receive one or more notifications when those conditions are met, rather than continuously polling and/or consuming raw sensing data streams.

The sensing enabler client 914 and/or the sensing enabler server 908 enable the one or more applications to control the lifecycle of Wi-Fi sensing services, including activation, modification, suspension, and/or termination etc. A lifecycle control is exposed through one or more application-level interfaces and is decoupled from user equipment connectivity and/or communication session state, allowing persistent and/or on-demand sensing services.

In FIG. 9B, the Wi-Fi SF 916 may collect the Wi-Fi sensing data from the one or more sensing enabler clients (e.g., the sensing enabler client 914) and provide it to one or more sensing enabler servers (e.g., sensing enabler server 908).

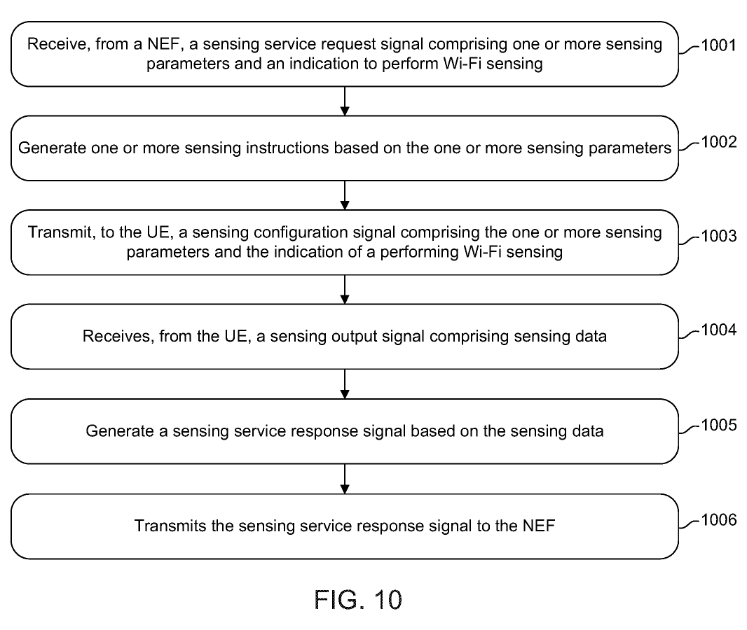

Referring now to FIG. 10, a flowchart illustrating a method performed by a network device is shown according to one or more implementations of the present disclosure.

At 1001, the network device receives, from a NEF, a sensing service request signal comprising one or more sensing parameters and an indication to perform Wi-Fi sensing.

At 1002, the network device generates one or more sensing instructions based on the one or more sensing parameters. In an implementation, the one or more sensing parameters include: a sensing type, a target area, a WLAN identifier, a reporting periodicity, one or more accuracy requirements, one or more latency constraints, or an authorization context.

At 1003, the network device transmits, to the UE, a sensing configuration signal comprising the one or more sensing instructions and the indication to perform Wi-Fi sensing. In an implementation, the sensing configuration signal is transmitted to the UE via an AMF.

At 1004, the network device receives, from the UE, a sensing output signal comprising sensing data. In an implementation, the sensing data comprises Wi-Fi sensing data. In an implementation, the Wi-Fi sensing data comprises one of: raw Wi-Fi sensing data, pre-processed Wi-Fi sensing data, or a combination of the raw Wi-Fi sensing data and the pre-processed Wi-Fi sensing data. In an implementation, the sensing data further comprises cellular sensing data. In an implementation, the sensing output signal is received from the UE via an internet protocol (IP) based interface.

At 1005, the network device generates a sensing service response signal based on the sensing data. In an implementation, generating the sensing service response signal comprises aggregating the Wi-Fi sensing data and one or more of: the cellular sensing data, historical sensing data, or contextual data to generate aggregated sensing data. In an implementation, the sensing service response signal comprises the aggregated sensing data. In an implementation, generating the sensing service response signal comprises one or more of: filtering the sensing data; extracting one or more features from the sensing data; generating one or more inferences based on the sensing data; or generating metadata associated with the sensing data. In an implementation, the metadata includes one or more of: a confidence level associated with the sensing data, one or more timestamps indicative of time of generation of the sensing data, or a geographic relevance indication associated with the sensing data.

At 1006, the network device transmits the sensing service response signal to the NEF.

In an implementation, the network device functions as a SF. In an implementation, the SF includes a SCF and a SPF.

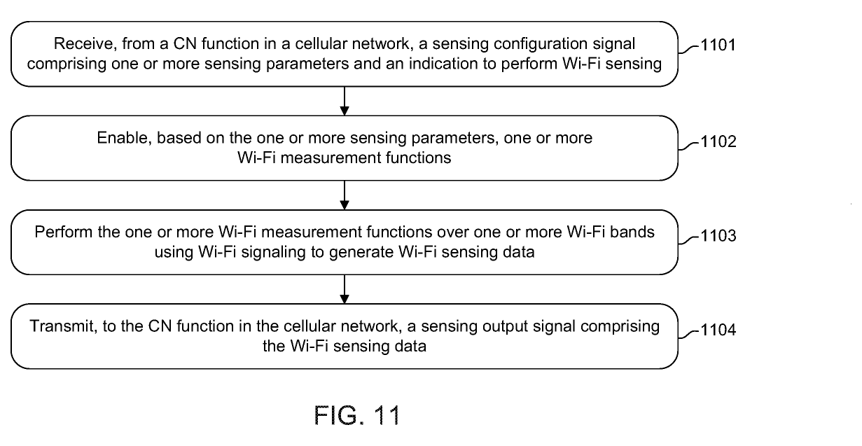

Referring now to FIG. 11, a flowchart illustrating a method performed by UE is shown according to one or more implementations of the present disclosure.

At 1101, the UE receives, from a CN function in a cellular network, a sensing configuration signal comprising one or more sensing instructions and an indication to perform Wi-Fi sensing.

At 1102, the UE enables, based on the one or more sensing instructions, one or more Wi-Fi measurement functions. In an implementation, the one or more Wi-Fi measurement functions comprise: collecting CSI, performing one or more fine timing measurements, or performing one or more radio measurements.

At 1103, the UE performs the one or more Wi-Fi measurement functions over one or more Wi-Fi bands using Wi-Fi signaling to generate Wi-Fi sensing data.

At 1104, the UE transmits, to the CN function in the cellular network, a sensing output signal comprising the Wi-Fi sensing data. In an implementation, the method further comprises generating, based on the sensing configuration signal, additional sensing data comprising one or more of: cellular sensing data, historical sensing data, or contextual data. The UE generates the sensing output signal comprising a combination of the Wi-Fi sensing data and the additional sensing data.

What is claimed is:

1. A method performed by a network device, the method comprising:
receiving, from a network exposure function (NEF), a sensing service request signal comprising one or more sensing parameters and an indication to perform Wi-Fi sensing;
generating one or more sensing instructions based on the one or more sensing parameters;
transmitting, to a user equipment (UE), a sensing configuration signal comprising the one or more sensing instructions and the indication to perform Wi-Fi sensing;
receiving, from the UE, a sensing output signal comprising sensing data;
generating a sensing service response signal based on the sensing data; and
transmitting the sensing service response signal to the NEF.

2. The method of claim 1, wherein the sensing data comprises Wi-Fi sensing data.

3. The method of claim 2, wherein the Wi-Fi sensing data comprises one or more of:
raw Wi-Fi sensing data, or
pre-processed Wi-Fi sensing data.

4. The method of claim 2, wherein the one or more sensing parameters include:
a sensing type,
a target area,
a wireless local area network (WLAN) identifier,
a reporting periodicity,
one or more accuracy requirements,
one or more latency constraints, or
an authorization context.

5. The method of claim 2, wherein the sensing data further comprises cellular sensing data.

6. The method of claim 5, wherein generating the sensing service response signal comprises:
aggregating the Wi-Fi sensing data and one or more of: the cellular sensing data, historical sensing data, or contextual data to generate aggregated sensing data.

7. The method of claim 6, wherein the sensing service response signal comprises the aggregated sensing data.

8. The method of claim 5, wherein generating the sensing service response signal comprises one or more of:
filtering the sensing data;
extracting one or more features from the sensing data;
generating one or more inferences based on the sensing data; or
generating metadata associated with the sensing data.

9. The method of claim 8, wherein the metadata includes one or more of:
a confidence level associated with the sensing data,
one or more timestamps indicative of time of generation of the sensing data, or
a geographic relevance indication associated with the sensing data.

10. The method of claim 1, wherein the sensing configuration signal is transmitted to the UE via an access and mobility management function (AMF).

11. The method of claim 1, wherein the sensing output signal is received from the UE via an internet protocol (IP) based interface.

12. A network device, comprising:
a transceiver; and
a processor, wherein the transceiver and the processor are configured to:
receive, from a network exposure function (NEF), a sensing service request signal comprising one or more sensing parameters and an indication to perform Wi-Fi sensing;
generate one or more sensing instructions based on the one or more sensing parameters;
transmit, to a user equipment (UE), a sensing configuration signal comprising the one or more sensing instructions and the indication to perform Wi-Fi sensing;
receive, from the UE, a sensing output signal comprising sensing data;
generate a sensing service response signal based on the sensing data; and
transmit the sensing service response signal to the NEF.

13. The network device of claim 12, wherein the sensing data comprises Wi-Fi sensing data.

14. The network device of claim 13, wherein the Wi-Fi sensing data comprises one or more of:
raw Wi-Fi sensing data, or
pre-processed Wi-Fi sensing data.

15. The network device of claim 13, wherein the one or more sensing parameters include:
a sensing type,
a target area,
a wireless local area network (WLAN) identifier,
a reporting periodicity,
one or more accuracy requirements,
one or more latency constraints, or
an authorization context.

16. The network device of claim 13, wherein the sensing data further comprises cellular sensing data.

17. The network device of claim 16, wherein generating the sensing service response signal comprises:
aggregating the Wi-Fi sensing data and one or more of: the cellular sensing data, historical sensing data, or contextual data to generate aggregated sensing data; and
wherein the sensing service response signal comprises the aggregated sensing data.

18. A method performed by a user equipment (UE), the method comprising:
receiving, from a core network (CN) function in a cellular network, a sensing configuration signal comprising one or more sensing instructions and an indication to perform Wi-Fi sensing;
enabling, based on the one or more sensing instructions, one or more Wi-Fi measurement functions;
performing the one or more Wi-Fi measurement functions over one or more Wi-Fi bands using Wi-Fi signaling to generate Wi-Fi sensing data; and
transmitting, to the CN function in the cellular network, a sensing output signal comprising the Wi-Fi sensing data.

19. The method of claim 18, wherein the one or more Wi-Fi measurement functions comprise:
collecting channel state information (CSI),
performing one or more fine timing measurements, or
performing one or more radio measurements.

20. The method of claim 18, further comprising:
generating, based on the sensing configuration signal, additional sensing data comprising one or more of:
cellular sensing data,
historical sensing data, or
contextual data; and
generating the sensing output signal comprising a combination of the Wi-Fi sensing data and the additional sensing data.
